(19) United States
(12) Patent Application Publication
(10) Pub. No.: US 2026/0093423 A1
(43) Pub. Date: Apr. 2, 2026

(54) MULTI-CHANNEL SELECTABLE PRIMER TO IMPROVE OVERALL IMAGE QUALITY FOR PIGMENTED INK-JET PRINTING

(71) Applicant: Xerox Corporation, Norwalk, CT (US)

(72) Inventors: Anthony Condello, Webster, NY (US); Seemit Praharaj, Marlborough, NH (US); Peter Gulvin, Webster, NY (US); Jason M. LeFevre, Penfield, NY (US); Jorge Alvarez, Webster, NY (US); Douglas K. Herrmann, Webster, NY (US); Varun Sambhy, Pittsford, NY (US); Mark Petropoulos, Webster, NY (US); Christine A. Steurrys, Williamson, NY (US); Ramesh Palghat, Pittsford, NY (US); Brian Lindstrom, Victor, NY (US)

(21) Appl. No.: 18/899,313

(22) Filed: Sep. 27, 2024

(51) Int. Cl. G06F 3/12; G06V 30/413

(52) U.S. Cl. CPC G06F 3/1208; G06F 3/1229; G06F 3/1254; G06V 30/413

(57) ABSTRACT

A method for operating a printing system, comprising: identifying at least one area in an electronic document for which one or more primers are to be applied prior to an application of ink on a sheet of media during a print job (wherein the primers are formulated to have different surface tensions); determining, for each pixel in the at least one area, an amount of each of the one or more primers that is to be applied based on a characteristic of content in the electronic document; generating the print job using the amount of each of the one or more primers determined for each said pixel in the at least one area; and instructing a printer to perform the print job.

### BACKGROUND

### Description of the Related Art

One way to ensure high quality and consistent print performance on a widening array of customer media, is to treat the surface of the media with a pre-coat (primer) prior to application of the ink. The pre-coat layer helps to keep the ink pigment near the surface and helps to make the media more readily de-inkable and recyclable.

However, not all pre-coat materials behave similarly. Depending on formulation, the pre-coat may act to spread the later jetted inks more or less than needed for optimal image quality (IQ). It is common to want greater spread in large solid regions, while fine features and text are benefited by much less spread to maintain sharp edges. It is difficult for a single pre-coat formulation to meet these conflicting requirements given a fixed ink formulation.

### SUMMARY

The present disclosure concerns implementing systems and methods for operating a printing system. The method comprises: identifying, by a processor, at least one area in an electronic document for which one or more primers are to be applied prior to an application of ink on a sheet of media during a print job (wherein the primers are formulated to have different surface tensions); determining, for each pixel in the at least one area, an amount of each of the one or more primers that is to be applied based on a characteristic of content in the electronic document; generating the print job using the amount of each of the one or more primers determined for each said pixel in the at least one area; and instructing and or controlling a printer to perform the print job.

The present disclosure also concerns a system, comprising: a processor; and a non-transitory computer-readable medium comprising one or more programming instructions that when executed by the processor, cause the processor to: identify at least one area in an electronic document for which one or more primers are to be applied prior to an application of ink on a sheet of media during a print job (wherein the primers are formulated to have different surface tensions); determine, for each pixel in the at least one area, an amount of each of the one or more primers that is to be applied based on a characteristic of content in the electronic document; generate the print job using the amount of each of the one or more primers determined for each said pixel in the at least one area; and instruct and or control a printer to perform the print job.

The present disclosure concerns implementing systems and methods for operating a printing system, comprising: identifying, by a processor, at least one two areas in an electronic document for which at least one primer is applied prior to an application of ink on a sheet of media during a print job (wherein the at least one primer is formulated to have a surface tension); determining, for each of the at least one two areas, a different amount of the at least one primer that is to be applied based on a characteristic of content in the electronic document; generating the print job using the amount of the at least one primer determined for each in the at least one area; and instructing and or controlling a printer to perform the print job.

The present disclosure concerns a sheet of media, comprising at least one side on which one or more primers were applied during a print job based on characteristics of an electronic document. The primers are formulated to have different surface tensions. At least two areas of the at least one side of the sheet of media have different amounts of a single one of the primers applied thereto or different amounts of at least two of the primers applied thereto.

### BRIEF DESCRIPTION OF THE DRAWINGS

The present solution will be described with reference to the following drawing figures, in which like numerals represent like items throughout the figures.

FIG. 1 provides an illustration that is useful for understanding a multi-channel selectable primer to improve image quality for pigmented ink-jet printing.

FIG. 2 provides an illustration of a system implementing the present solution.

FIG. 3 provides an illustration showing an illustrative primer application performed by the system of FIG. 2.

FIGS. 4A-4B (collectively referred to as “FIG. 4”) provides a flow diagram of an illustrative method for operating a printing system.

FIG. 5 provides an illustration of an electronic document to be printed.

FIG. 6 provides an illustration showing pixels of an electronic document.

FIG. 7 provides a flow diagram of another illustrative method for operating a printing system.

FIG. 8 provides an illustration of a sheet of media with primer(s) disposed thereon.

FIG. 9 provides a block diagram of an illustrative architecture for a computing device.

### DETAILED DESCRIPTION

As noted above, one way to ensure high quality and consistent print performance on a widening array of customer media, is to treat the surface of the media with a pre-coat (primer) prior to application of the ink. The pre-coat layer helps to keep the ink pigment near the surface and helps to make the media more readily de-inkable & recyclable.

However, not all pre-coat materials behave similarly. Depending on formulation, the pre-coat may act to spread the later jetted inks more or less than needed for optimal Image Quality. It is common to want greater spread in large solid regions, while fine features and text are benefited by much less spread to maintain sharp edges. It is essentially impossible for a single pre-coat formulation to meet these conflicting requirements given a fixed ink formulation.

Jobs and customer expectations can vary greatly from job-to-job, print-to-print or even within-print. Making the ability for an employee to immediately address image quality (IQ) control is considered an extremely valuable press feature. Thus, the present document concerns a system having multiple primer options available. Further, each primer can be digitally applied precisely where it is needed and in the optimum amount. In addition, that two or more unique primer formulations may be deposited near enough to each other on the media to provide an “In-between” spread effect. That is to say, if “low” and “high” spread primers were jetted in close proximity onto the sheet that they would promote a “medium” amount of ink spread.

The present solution concerns a unique system that is configured to selectively apply primer to a substrate prior to jetting ink. The primers are jetted from addressable printhead(s). The formulation of each individual primer is different enough to promote more or less spreading of the ink once the ink is jetted onto the primer. It is possible to implement this technology in-line for either a cut-sheet or web fed machine (e.g., a Bernese Family, Cost-Down Hybrid Color Machine or a label press).

The use of primer can go a long way toward making different media react similarly for a given ink-set. In this way, image quality consistency and overall customer satisfaction regardless of the paper choice is enhanced. For example, when applied to uncoated porous paper, the primer may function to keep the ink at or near the surface and improve color gamut. When used on coated media, it may help to control the spread of the individual drops and restrict color bleed. In general, there would be no widespread differences in the image as a function of media. While use of a single primer would do well to neutralize image quality difference on various media, it does not support those instances when spread variation is desired (e.g., image content requiring uniform solids (more spread, no streaks) or those demanding sharp edges (less spread, micro-stability)).

The present solution is capable of using at least two separate formulations of primer at the same time. One primer formulation is configured to have a surface tension significantly different (higher or lower) than the other primer formulation. The exact surface tension levels will be dependent on the surface tension of the ink. In addition to having the ability to jet no primer, fine-feature primer or solid area primer, it is also possible to produce any combination of these three options (limited by resolution), in order to optimize performance on any portion of the print. The present solution provides a novel system implementation and introduces fundamental benefits not presently known or found in the art.

The present solution provides a system with highly adaptable within print image quality control, customizable (unique artifact) image quality opportunities, many performance options (e.g., optional primer application, selectable spread type (high or low), selectable render (high or low), optional combination of primers on print), unique media/image dependent primer laydown recipes possible, and improved de-inkablity.

The present solution also concerns implementing systems and methods for high quality printing using addressable two-part precoat. When printing high quality inkjet images, many of the image quality defects are due to how the ink interacts with the media, and in particular how much the ink spreads. If the ink spreads too little, then the following may occur. The media can show through and change the apparent color (e.g., colors look lighter on white paper). Prints may be streaky, especially when nozzles are slightly misdirected. Missing jets may be more evident even after applying missing jet correction algorithms. In contrast, if the ink spreads too much, then the following may occur. Colors that are supposed to be adjacent can flow into each other and get muddy and fuzzy. Edges of lines can preferentially spread down certain paper fibers, leading to ragged lines and text. Small positive font can become deformed and hard to read. Small negative font and lines can fill in and can even disappear.

Using a precoat layer can reduce spread by causing the pigment in the ink to crash out and immobilize it, fixing the “spread too much” problems, but in the process, it worsens the defects caused by the spread being too low. Generally the precoat is applied either over the whole image by analog means, or applied digitally via a printhead everywhere ink is present. Digitally applying the precoat in only certain areas depending on the image content may help, but it's not always an option for a couple of reasons. A first reason is that uncoated media absorbs too much of the ink and/or pigment into the inside of the paper where it can't be seen. So, the no-precoat areas may look washed out (low gamut), and have the potential for show-through onto the back of thinner media. A second reason is that the precoat is also used to improve deinkability by keeping the pigment near the surface where it can be more easily removed during recycling. Having any printed features without precoat underneath may compromise that deinkability benefit.

The present solution comprise a two-part precoat. A first precoat is applied everywhere ink will be applied via jetting or possibly over the entire sheet by analog means, with the intent to allow deinking, improve gamut, and reduce show-through. This can be accomplished by the addition of a small amount of polymers that keep the pigment from penetrating into the paper. A second precoat is applied intelligently based on the image content only in regions that would benefit from reduced spread. This can be done by adding calcium or magnesium salts to crash out the pigment in the ink. These two precoats may be jetted from the same two-color printhead, since there is no problem with them mixing on the media surface. Alternatively, the two precoats could be in separate printheads and applied in either order.

When the ink is being developed and/or chosen, the system may prioritize having increased spread on the range of medias of interest, instead of having to fine tune the spread to walk a fine line between the failure modes of too much or too little spread. Areas that need the second precoat (e.g., salts) applied thereto may include, for example, fine features, small text, edges of large text, and near borders where two colors come together or where they would otherwise bleed into each other. It could also be used to better hide the tiny drops that are printed to reduce printhead latency issues (sneezing), and to reduce graininess in sparse fill areas. Depending on the precoat and how it interacts with ink, the precoat can be dried before printing on it, or it can be left wet and dried after the print is complete. The two-precoat solution allows tailoring of ink spread in different areas of a printed image while remaining deinkable, maintaining color gamut, and minimizing showthrough.

The present solution can be used in various applications. For example, the present solution can be used in image printing applications, gloss control applications, and/or overcoat or varnish applications.

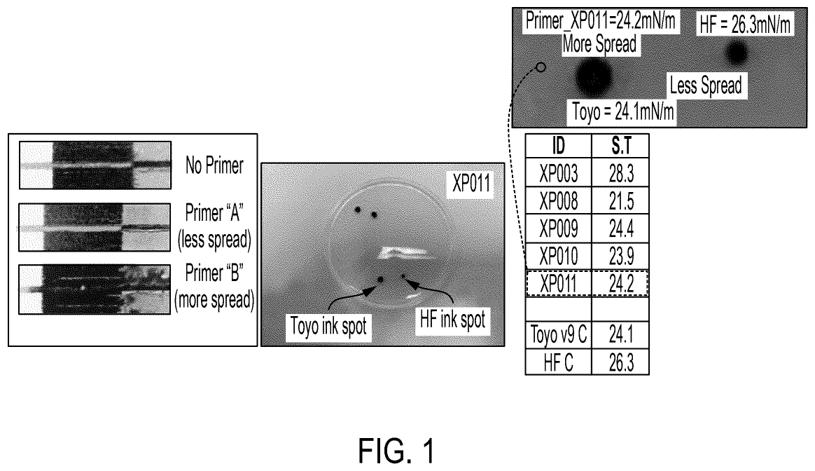

FIG. 1 provides an illustration demonstrating how drops of higher surface tension spread less on/in a lower surface tension medium. The larger spread dot could be used for solid areas of a sheet, while a smaller spread dot could be used for fine features and text. The manner in which these dots are used in a printing system will now be described in detail.

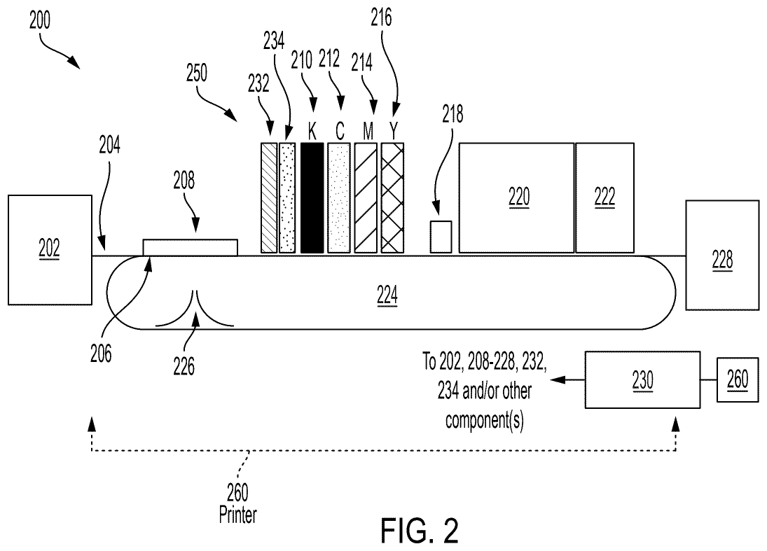

FIG. 2 provides an illustration of system 200 implementing the present solution.

System 200 can include, but is not limited to, a Bernese Aqueous Inkjet printing press, and/or a multifunction printer, scanner or copier. System 200 comprises a printer 260 that is generally configured to print text, graphics and/or images on sheets of inkjet treated sheets or non-Inkjet treated sheets with or without coating(s). The inkjet treated sheets or non-inkjet treated sheets can include, but are not limited to, sheets of paper with no coating, sheets of paper with a glossy coating, sheets of paper with a matte coating, and/or sheets of paper with a silk coating.

System 200 comprises a feeder module 202 configured to automatically pick up sheet(s) of media and feed the same into the printer 260 one sheet at a time via a media feed path 204. Any known or to be known feeder module can be used here.

Printer 260 comprises a registration transport assembly 208, printhead(s), machine vision sensor(s) 218, dryer module(s) 220, and a cooling module 222. Each of the listed components 208-222 is known. The machine vision sensor(s) 218 can include, but is (are) not limited to, camera(s), laser sensor(s), thermal imaging sensor(s), and/or other vision sensor(s).

The registration transport assembly 208 is generally configured to properly align the sheet of media and place it in the media path 206 so that any impression on the sheet occurs in the precise position as intended. The impression can include, but is not limited to, ink marking(s) or dot(s). The sheet continues on the media path 206 towards the printhead(s) 250. Printhead(s) 250 comprise one or more channels 232, 234, 210-216 through which primer(s) and/or inks flow. Accordingly, blocks 232, 234, 210-216 represent different printheads or different channels in one or more printheads. Blocks 232, 234, 210-216 are referred to herein as channels. However, the present solution is not limited in this regard.

Channels 232, 234 are generally configured to apply primers or pre-coats to sheets of media prior to any application of ink thereon. The primers or pre-coats are formulated to have different surface tensions. In this regard, each primer or pre-coat can include, but is not limited to, a polymer based liquid with a particular amount of Surfactant added thereto a salt (calcium or magnesium salt) based liquid with a particular amount of Surfactant added thereto, or a polymer and salt based liquid with a particular amount of Surfactant added thereto.

Channel 232 is configured to apply a first primer or pre-coat formulated to allow for a relatively small amount of ink spread on a sheet of media. A relatively small amount of ink spread may mean less than an additional pixel of spread. The first primer or pre-coat has a relatively small dose of Surfactant, is applied to provide dots of a relatively small size, and has a large or small drop size. A dot refers to a round mark or spot comprising a portion of a liquid (e.g., primer or ink) disposed on a sheet of media. A drop refers to round or pear-shaped portion of a liquid (e.g., primer or ink) that falls from a thing (e.g., a printhead or channel). The term “dot size”, as used herein, refers to a size of a dot which may be defined in terms of a diameter or other geometric dimension. The size “drop size”, as used herein, refers to a size of a drop which may be defined in terms of a diameter or other geometric dimension. A small dot size may range from, for example, 0.5-3.0 pl. A large dot size may range from, for example, 3.0-10 pl. A large drop size ranges from four picolitres to twenty-two picolitres, while a small drop size ranges from zero picolitres to four picolitres. In some scenarios, the large drop size is selected to be four picolitres and the small drop size is selected to be 1.9 picolitres. The present solution is not limited in this regard.

Channel 234 is configured to apply a second primer or pre-coat formulated to allow a relatively large amount of ink spread on a sheet of media. A relatively large amount of ink spread may be more than an additional pixel of spread. The second primer or pre-coat has a relatively large dose of Surfactant, is applied to provide dots of a relatively large size, and has a large or small drop size.

The following TABLE 1 shows the particulars and differences between the first and second primers/pre-coats. In TABLE 1, the first primer/pre-coat is referred to as primer/pre-coat A and the second primer/pre-coat is referred to as primer/pre-coat B.

TABLE 1

| | Dot | Drop | Surface | Ink |
|---|---|---|---|---|
| Primer/Pre-Coat | Size | Size | Tension | Spread |
| A | Small | Large | Low | Small |
| | | or Small | | |
| B | Large | Large | High | Large |
| | | or Small | | |

In some scenarios, Primer A Low Surface Tension may be prepared by mixing the following ingredients 4.35 g Proxel Biocide, 65.4 g Glycerol, 593.1 g propylene glycol, 1533 g water, 35.1 g Dynol 607 surfactant, 3 g TegoTwin4000 surfactant and 900 g magnesium nitrate hexahydrate. This primer A has surface tension of 21.03 mN/m as measured using Kruss 100 tensiometer. Primer B High Surface Tension may be prepared by mixing the following ingredients 1.42 g Proxel Biocide, 21.3 g glycerol, 192.7 g Propylene glycol, 497 g water, 11.5 g Dynol 607 surfactant, and 290 magnesium nitrate hexahydrate. This primer B has a surface tension of 28.31 mN/m as measured using Kruss 100 tensiometer. The present solution is not limited to the particulars of this scenario. Primers A and B can be prepared by mixing other ingredients than those listed.

The same or different amounts of primer/pre-coats A and B can be applied for each pixel or area of an image to be inkjet printed by a printer 260. For example, system may be configured during a first print job to apply different amounts of either primer A or B on different areas of a sheet of media. The different amounts of primer A or B may be defined in terms of drop size and/or percentage of a composite primer. Accordingly, the system may be configured during a first print job to apply only one of the primers A and B on a sheet of media, wherein the drop size of the single primer is varied as it is applied to a sheet of media. Additionally or alternatively, the system may be configured during the first print job or another print job to (i) apply 10% primer/pre-coat A and 90% primer/pre-coat B for first pixel(s) or area(s) on a sheet of media, (ii) 60% primer/pre-coat A and 40% primer/pre-coat B for second pixel(s) or area(s) on the sheet of media, (iii) 100% primer/pre-coat A and 0% primer/pre-coat B for third pixel(s) or area(s) on the sheet of media, and so on. The present solution is not limited to the particulars of this example. The amount of primers/pre-coats to be applied on a per-area basis or a per-pixel basis may be selected based on, for example, media type, temperature of media, expected or predicted temperature of media at a time when a primer/pre-coat is to be applied, type of image content, ink color, ink type, and/or scanner data from previous print job. The scanner data can indicate an amount of ink spread on a sheet of media. Primers/pre-coats A and B may be dried before applying ink on a sheet of media, or alternatively dried along with the applied ink.

The following TABLE 2 shows illustrative percentages of primers A and B to be applied based on feature type.

TABLE 2

| | Percentage of | Percentage of |
|---|---|---|
| Feature Type | Primer/Pre-coat A | Primer/Pre-coat B |
| White Space | 100% (optionally) | 0% |
| Fine Feature | 51-100% | 0%-49% |
| Non-Fine Feature | 0%-49% | 51-100% |
| Small Text | 51-100% | 0%-49% |
| Large Text Edge | 51-100% | 0%-49% |
| Large Text Middle | 0%-49% | 51-100% |
| Object Edge | 51-100% | 0%-49% |
| Object Middle | 0%-49% | 51-100% |
| Adjacent Color | 51-100% | 0%-49% |
| Border | | |

The present solution is not limited to the particulars of TABLE 2. Other percentages can be used in accordance with a given application. A fine feature can include, but is not limited to, a relatively thin line. The relatively thin line may have a line weight equal to or less than 1 pt. A non-fine feature may comprise a relatively thick line or a shaped object. The relatively thick line may have a line weight greater than 1 pt. Thus, an area of a sheet may be associated with a non-fine feature, an object edge and/or an object middle.

Channels 210-216 are generally configured to transfer color onto sheet(s) of media. For example, channel 210 is configured to apply ink of a key color on sheet(s). The key color can include, but is not limited to, black. Channel 212 is configured to apply cyan ink on sheet(s). Channel 514 is configured to apply magenta ink on sheet(s). Channel 216 is configured to apply yellow ink on sheet(s).

The applied ink may be dried by dryer module(s) 220. A cooling module 222 is provided to cool the sheet of media after passing through the dryer module(s) 220 and cause the sheet of media to either (i) return to the beginning of the process via a duplex return path 524 or (ii) continue to an outfeed module 228 where it is put in a tray for retrieval by a user.

A controller 230 is provided for controlling operations of components 202, 208-222, 226, 228, 232, 234 of system 200. Controller can include, but is not limited to, a processor, a computing device, and/or an electronic circuit. Controller 230 implements the present solution for improving image quality. In this regard, controller 230 is configured to receive user input and/or generate print jobs in response to the user inputs. The user inputs can be facilitated by a user interface allowing user software interactions for selecting print job parameters. A user can perform a user software interaction to select one or more of the following options for a given print job: a No Primer option, a Fine-Feature Primer option, and/or a Solid Area Primer option. The No Primer option causes no primer or pre-coat to be applied to a sheet of media. A Fine-Feature Primer causes the first primer/pre-coat and the second primer/pre-coat to be applied to area(s) of the sheet in which fine-features are to be printed with ink. In the fine feature case, the amount of the first primer pre-coat applied to the area(s) of the sheet is greater than the amount of the second primer/pre-coat applied to the area(s) of the sheet. The Solid Area Primer option cause the first primer/pre-coat and the second primer/pre-coat to be applied to area(s) of the sheet in which large text or other objects are to be printed with ink. In the solid area case, the amount of the first primer pre-coat applied to the area(s) of the sheet is less than the amount of the second primer/pre-coat applied to the area(s) of the sheet. The following TABLE 3 illustrates the differences in the amount of primers/pre-coats A and B that are to be applied in accordance with each option.

TABLE 3

| Primer Options | Primer/Pre-Coat Amounts |
|---|---|
| No Primer | A = B = 0% |
| Fine Feature Primer | A % > B % |
| Solid Area Primer | A % < B % |

The present solution is not limited to the particulars of TABLE 3. Other primer options can be defined in accordance with a given application.

The controller is also configured to (i) receive a request to print a document, (ii) generate a print job in response to the request, and (iii) command, control or otherwise instruct the printer 260 to perform the print job. The print job may be defined by a bit map for one or both sides of a sheet of media. Bit maps are known. However, the bit map generated here includes additional information specifying the percentages of primers/pre-coats A and B for each pixel. The print job is generated by performing the following operations: (1) parsing the print request to obtain the type of media to be used; (2) analyzing the document to identify first areas of the sheet of media to which no ink is to be applied (i.e., white spaces); (3) analyzing the document to identify second areas of a sheet of media to which ink is to be applied; (4) determining the type of media content associated with each of the second areas (e.g., fine feature, small text, large text, solid color object, etc.); (5) determining, for each pixel in the second area, the type of ink and the color of ink to be applied; (6) identifying or classifying ones of the pixels as being of a text/object edge pixel type or an adjacent color border type; (7) optionally obtaining scanner data associated with previous print job(s); (8) optionally detecting, measuring or otherwise obtaining a temperature of a sheet of media to be used for the print job; (9) optionally obtaining an expected or predicted temperature of the sheet of media when a second side of the sheet is to be printed during a Duplex print job; (10) determining, for each pixel, an amount of each primer/pre-coat A and B to be applied based on the information obtained in previous operations (1)-(6) and optionally (7), (8) and/or (9); and (11) building the bit map based on results of the previous operations.

In a Duplex scenario, primer/pre-coat and ink are applied to both sides of the sheet of media. For example, the printer 260 applies primer(s) and ink to a first side of the sheet and then applies primer(s) and ink to the second side of the sheet of media. The primer(s) and colored ink(s) applied to the first side of the sheet may be dried by dryer module(s) 220 before returning the sheet to the start of the media path 206 for printing on the second side. In this case, the temperature of sheet is higher when printing on the second side as opposed to when printing on the first side occurred. The system may account for this temperature difference by adjusting the amounts of first and second primers for each feature type to be different on the second side as compared to the first side of the sheet.

During performance of each print job, the controller 230 may control machine vision sensor(s) 218 to acquire scanner data for the first and/or second sides of the sheet of media. The scanner data can include information that is useful for detecting an amount of ink spread on one or both sides of the sheet of media. The controller 230 may then analyze the scanner data to determine, for example, whether the sheet of media has a target amount of ink spread. The controller 230 may then optionally modify, adjust, update or otherwise change the bit map generation rules based on the scanner data analysis and/or results of this determination. For example, the controller may modify, adjust, update or otherwise change the bit map generation rules for determining how much primer of types A and B should be applied for one or more feature types.

During execution or performance of the print job, the controller 230 control, instructs or otherwise causes the feeder module 202 to feed a sheet of media into the printer 260. The printer 260 is then controlled, instructed or otherwise caused to: apply primers/pre-coats to a first side of the sheet of media in a pixel-by-pixel manner; apply ink in the form of dots on the first side of the sheet of media in a pixel-by-pixel manner; dry the primers/pre-coats and ink applied to the first side of the sheet; optionally cause the dried sheet to travel along the duplex return path 224; optionally apply primers/pre-coats to a second side of the sheet of media in a pixel-by-pixel manner; optionally apply ink in the form of dots on the second side of the sheet of media in a pixel-by-pixel manner; optionally dry the primers/pre-coats and ink applied to the second side of the sheet; and cause the sheet of media to be passed to the outfeed module 228. The above listed operations can be performed in a different order. For example, the primers/pre-coats can be dried prior to any application of the ink on one or both sides of the sheet of media.

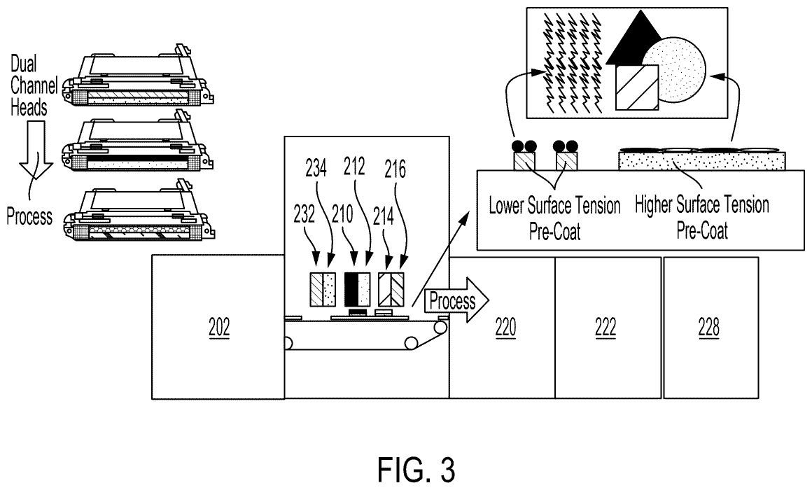

FIG. 3 provides an illustration that is useful for understanding a print job performed by the system 200 of FIG. 2. The illustrative print job involves: applying a lower surface tension pre-coat to areas of a sheet of media that are associated with text, fine lines, and fine features; and applying a higher surface tension pre-coat to areas of a sheet of media that are associated with solid area features. The present solution is not limited to the particulars of FIG. 3.

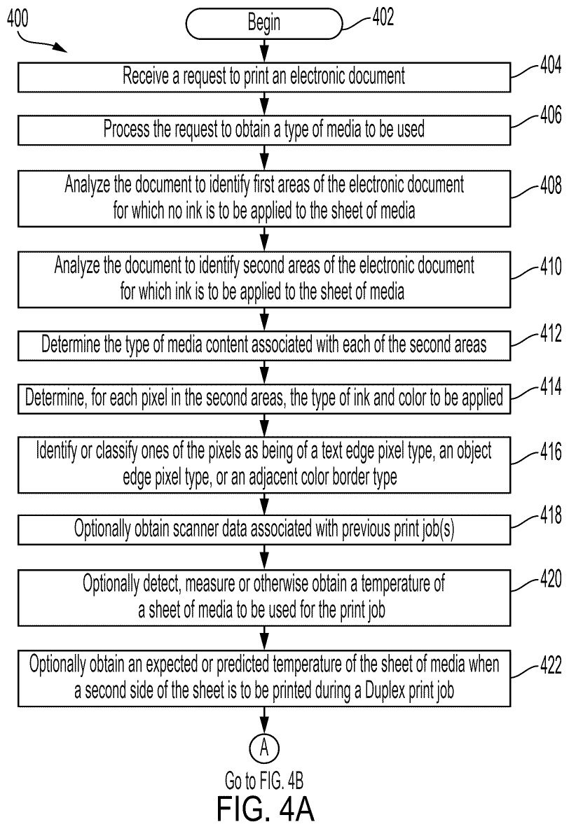

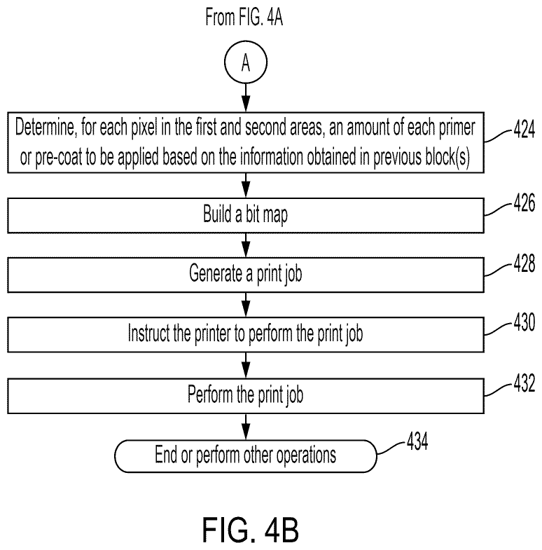

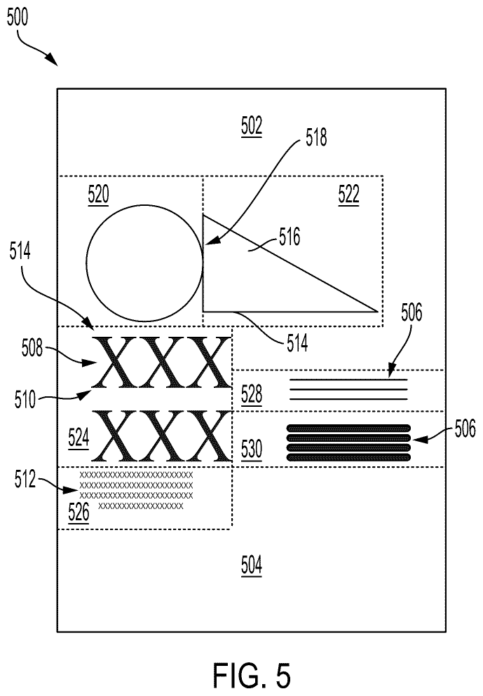

FIG. 4 provides a flow diagram of a method 400 for improving image quality. The operations of FIG. 4 may be performed in the same or a different order than that shown. Method 400 begins with 402 and continues with block 404 where a controller (e.g., controller 230 of FIG. 2) receives a request to print a document. Such requests are known. However, the request of the present solution may include additional information specifying that the user selected a No Primer option, a Fine-Feature Primer option, and/or a Solid Area Primer option. The request can be made responsive to a user software interaction via a user interface (e.g., user interface 260 of FIG. 2). The document can include any type of electronic document. For example, the document can include an electronic document 500 as shown in FIG. 5. The electronic document may be, for example, in a which may be in a PDF format. The present solution is not limited in this regard. The request is processed by the controller in block 406 to at least obtain a type of media to be used.

The controller analyzes the electronic document in block 408 to identify first areas thereof for which no ink is to be applied to the sheet of media. The first areas may be referred to as white spaces. Thus, the controller may classify the first areas as being of a white space type. For example, the controller may identify areas 502 and 504 of the electronic document 500 in block 408 and classify these areas as white spaces. The present solution is not limited in this regard.

In block 410, the controller analyzes the electronic document to identify second areas thereof for which ink is to be applied to the sheet of media. For example, the controller may identify areas 520, 522, 524, 526, 528, 530 of electronic document 500 in block 410. The present solution is not limited in this regard. Once the second areas have been identified, the controller performs operations in block 412 to determine the type of media content associated with each of the second areas. For example, the controller determines that area 520 is associated with an object or solid area feature, area 522 is associated with an object or solid area feature, area 524 is associated with large text, area 526 is associated with small text, area 528 is associated with fine features, and area 530 is associated with non-fine features. The present solution is not limited in this regard. Other types of media content can be used here.

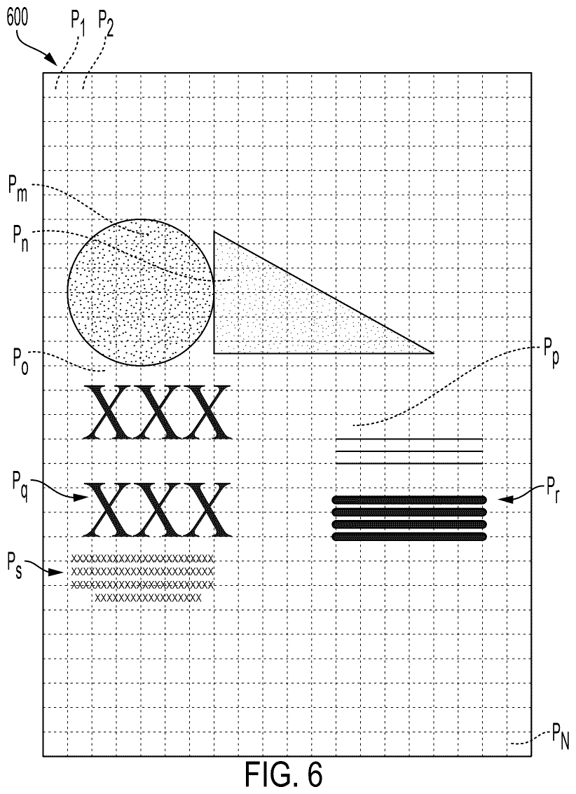

Next in 414, the controller determines the type of ink and color to be applied for each pixel in the second areas. The different types of ink can include, but are not limited to, dye-based ink, pigment based ink, alcohol ink, glitter ink, metallic ink, solvent, eco-solvent, latex, ultraviolent, and/or aqueous. For example, with reference to FIG. 6, the controller determines that dark grey aqueous ink is to be applied for pixel Pₘ, light grey aqueous ink is to applied for pixel Pₙ, and so on. The present solution is not limited to the particulars of this example.

In 416, the controller performs operations to identify or classify ones of the pixels as being of a text edge pixel type, an object edge pixel type, or an adjacent color border type. For example, with reference to FIG. 6, the controller determines Pₘ as being an object edge pixel type, pixel Pₙ as being of an object edge pixel type and an adjacent color border type, pixel P_{P} as being of an object edge pixel type. The present solution is not limited to the particulars of this example.

Upon completing the operations of block 416, method 400 may continue with optional operations of blocks 418-422. The optional operations involve: obtaining scanner data associated with previous print job(s); detecting, measuring or otherwise obtaining a temperature of a sheet of media to be used for the print job; and/or obtaining an expected or predicted temperature of the sheet of media when a second side of the sheet is to be printed during a Duplex print job. Thereafter, method 400 continues to block 424 of FIG. 4B.

Block 424 involves performing operations by the controller to determine, for each pixel in the first and second areas, an amount of primer or pre-coat to be applied based on the information obtained in the previous blocks. The amount of primer or pre-coat may be defined in various ways. For example, the amount of the primer may be defined as a percentage of a primer and/or a drop size. This determination may be based on media type, actual temperature of media, expected temperature of media, type of image content, ink color, ink type, and/or scanner data from previous print jobs. For example, with reference to FIG. 6, the controller may determine an amount of primer A and an amount of primer B to be applied for each pixel P₁, . . . , P_{N} based on media type, actual temperature of media, expected temperature of media, type of image content, ink color, ink type, and/or scanner data from previous print jobs. Primer A may be formulated to allow a relatively small amount of ink spread, while primer B may be formulated to allows a relatively large amount of ink spread. The controller determines that: primer is to be applied for pixels P₁, P₂, . . . , P_{N} in white spaces 502, 504 such that it comprises 100% primer A or alternatively 0% of primers A and B; primer is to be applied for object edge pixels Pₘ of area(s) 520-530 such that it comprises 51-100% primer A and 0%-49% primer B; primer is to be applied for adjacent border pixels Pₙ of area(s) 520-530 such that it comprises 51-100% primer A and 0%-49% primer B; primer is to be applied for large text pixels P_{q} of area(s) 520-530 such that it comprises 51-100% primer A and 0%-49% primer B; primer is to be applied for small text pixels Pₛ of area(s) 520-530 such that it comprises 51-100% primer A and 0%-49% primer B; primer is to be applied for fine feature pixels P_{q} of area(s) 520-530 such that it comprises 51-100% primer A and 0%-49% primer B; and primer is to be applied to non-fine feature pixels Pᵣ of area(s) 520-530 such that it comprises 0%-49% primer A and 51-100% primer B. The present solution is not limited to the particulars of this example.

Block 424 may also involve determining, for each pixel within a certain distance from an edge pixel of the feature (e.g., text or object) in the second area(s), the amount of primer or pre-coat to be applied. The certain distance can be selected in accordance with a given application. For example, the certain distance may be N pixels from an edge pixel, where N is any integer equal to or greater than zero or one.

Next in blocks 426-428, the controller builds a bit map and generates a print job in accordance with any known or to be know technique. The controller instructs the printer (e.g., printer 260 of FIG. 2) to preform the print job as shown by block 430. The print job is performed in bock 432. Thereafter, method 400 continues to block 434 where it ends or other operations are performed (e.g., return to 402 of FIG. 4A).

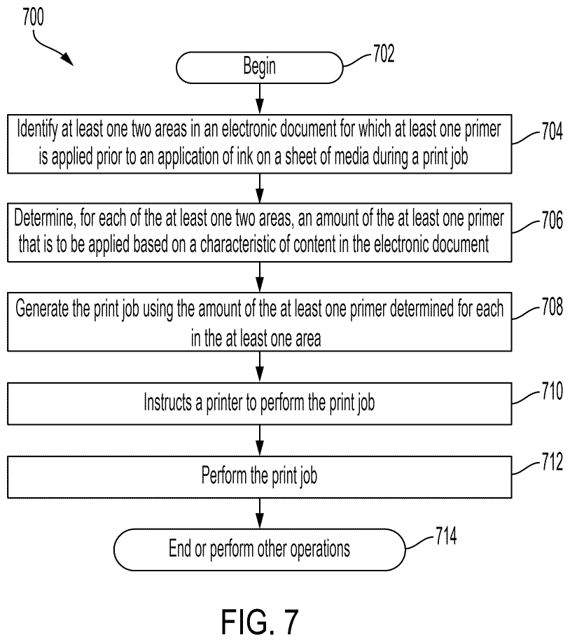

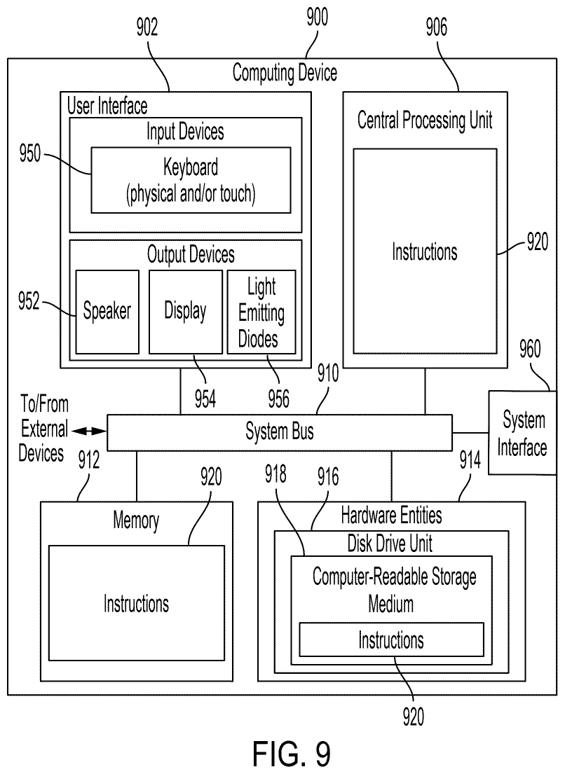

FIG. 7 provides a flow diagram of another illustrative method 700 for operating a printing system (e.g., printing system 200 of FIG. 2). Method 700 begins with 702 and continues with 704 where a processor (e.g., controller 230 of FIG. 2 and/or central processing unit 906 of FIG. 9) performs operations to identify at least one two areas in an electronic document for which at least one primer is applied prior to an application of ink on a sheet of media during a print job. Each primer is formulated to have a given surface tension. The surface tensions of two primers may be different. In 706, the processor performs operations to determine, for each of the at least one two areas, an amount of the at least one primer that is to be applied based on a characteristic of content in the electronic document. The amount of the primer may be defined in terms of a drop size. The processor generates the print job in block 708 using the amount of the at least one primer determined for each in the at least one area. The processor instructs a printer (e.g., printer 260 of FIG. 2) to perform the print job, as shown by block 710. Responsive to the instructions, the printer performs the print job in block 712. Subsequently, method 700 continues to block 714 where it ends or other operations are performed (e.g., return to 702).

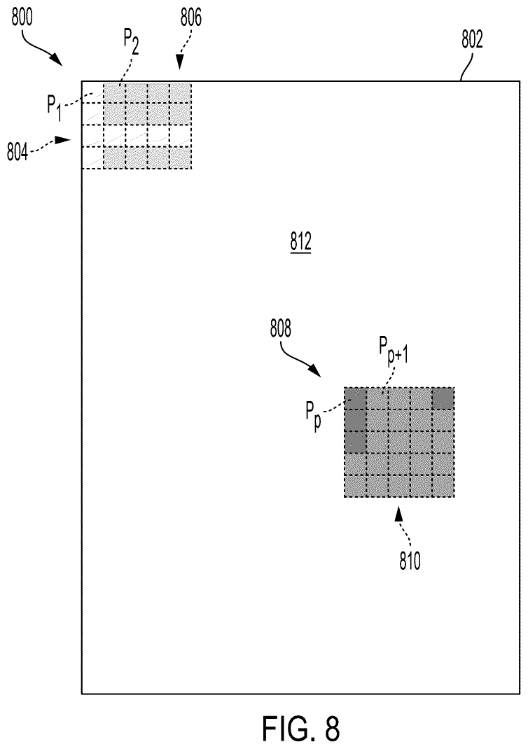

FIG. 8 provides an illustration of a sheet of media 800 produced in accordance with the present solution. The sheet 800 has at least one side 802 on which one or more primers (e.g., primers A and/or B) were applied during a print job based on characteristics of an electronic document (e.g., electronic document 500 of FIG. 5). The primers are formulated to have different surface tensions. Two or more pixels P₁, P₂ and/or areas 804, 806 of side 802 have a single primer applied thereto (e.g., primer A or B), while other pixels P_{P}, P_{P+1} and/or areas 808, 810 of side 802 have a composite primer applied thereto that includes a combination of multiple primers (e.g., primers A and B).

As seen in FIG. 8, a different amount of the single primer has been applied in relation to pixel P₁ or area 804 as compared to pixel P₂ or area 806. This may have been achieved using different drop sizes for the primer applied in relation to pixels P₁, P₂ and/or areas 804, 806.

Pixels P_{P}, P_{P+1} and/or areas 808, 810 have different amounts of two or more different primers (e.g., primers A and B) applied thereto. For example, a drop of a composite primer was applied in relation to pixel P_{P} that included a relatively large amount of a first primer (e.g., primers A) and a relatively small amount of a second primer (e.g., primer B). In contrast, a drop of a composite primer was applied in relation to pixel P_{P+1} that includes a relatively small amount of the first primer and a relatively large amount of the second primer. Alternatively, a relatively large drop of the first primer was applied in relation to pixel P_{P} and a relatively small drop of the second primer was applied on top of the first primer at the location on sheet 800 corresponding to pixel P_{P}, while a relatively small drop of the first primer was applied in relation to pixel P_{P+1} and a relatively large drop of the second primer was applied on top of the first primer at the location on sheet 800 corresponding to pixel P_{P+1}.

Other pixels and/or area 812 do not have any primers applied thereto. Use of the present solution to produce sheet 800 is detectable. For example, sheet 800 may have different amounts of ions in the different areas 804, 806, 808, 810 and/or 812 thereof based on the primers respectively applied thereto.

Referring now to FIG. 9, there is shown an illustrative architecture for a computing device 900. The controller 230 of FIG. 2 is/are the same as or similar to computing device 900. As such, the discussion of computing device 900 is sufficient for understanding the controller 230 of FIG. 2.

Computing device 900 may include more or less components than those shown in FIG. 9. However, the components shown are sufficient to disclose an illustrative solution implementing the present solution. The hardware architecture of FIG. 9 represents one implementation of a representative computing device configured to receive information, process the receive information, transmit information and/or control operations of an aerial vehicle, as described herein. As such, the computing device 900 of FIG. 9 implements at least a portion of the method(s) described herein.

Some or all components of the computing device 900 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 9, the computing device 900 comprises a user interface 902, a Central Processing Unit (CPU) 906, a system bus 910, a memory 912 connected to and accessible by other portions of computing device 900 through system bus 910, a system interface 960, and hardware entities 914 connected to system bus 910. The user interface can include input devices and output devices, which facilitate user-software interactions for controlling operations of the computing device 900. The input devices include, but are not limited to, a physical and/or touch keyboard 950. The input devices can be connected to the computing device 900 via a wired or wireless connection (e.g., a Bluetooth® connection). The output devices include, but are not limited to, a speaker 952, a display 954, and/or light emitting diodes 956. System interface 960 is configured to facilitate wired or wireless communications to and from external devices (e.g., network nodes such as access points, etc.).

At least some of the hardware entities 914 perform actions involving access to and use of memory 912, which can be a Random Access Memory (RAM), a disk drive, flash memory, a Compact Disc Read Only Memory (CD-ROM) and/or another hardware device that is capable of storing instructions and data. Hardware entities 914 can include a disk drive unit 916 comprising a computer-readable storage medium 918 on which is stored one or more sets of instructions 920 (e.g., software code) configured to implement one or more of the methodologies, procedures, or functions described herein. The instructions 920 can also reside, completely or at least partially, within the memory 912 and/or within the CPU 906 during execution thereof by the computing device 900. The memory 912 and the CPU 906 also can constitute machine-readable media. The term “machine-readable media”, as used here, refers to a single medium or multiple media (e.g., a centralized or distributed database, and/or associated caches and servers) that store the one or more sets of instructions 920. The term “machine-readable media”, as used here, also refers to any medium that is capable of storing, encoding or carrying a set of instructions 920 for execution by the computing device 900 and that cause the computing device 900 to perform any one or more of the methodologies of the present disclosure.

In view of the forgoing, the present solution concerns a method for operating a printing system. The method comprises the following operations: (i) identifying, by a processor, at least one area in an electronic document for which one or more primers are to be applied prior to an application of ink on a sheet of media during a print job (wherein the primers are formulated to have different surface tensions); (ii) determining, for each pixel in the at least one area, an amount of each of the one or more primers that is to be applied based on a characteristic of content in the electronic document; (iii) generating the print job using the amount of each of the one or more primers determined for each said pixel in the at least one area; instructing a printer to perform the print job; and/or (iv) performing the print job by a printer or controlling the printer to perform the print job.

The print job may comprise applying both a first primer with a low surface tension and a second primer with a high surface tension to the sheet of media at a location corresponding to the at least one area of the electronic document. Additionally or alternatively, the print job may comprise: applying a lower surface tension primer to the sheet of media at a location that is associated with a text feature or a fine feature of the electronic document; and applying a higher surface tension primer to the sheet of media at another location that is associated with a solid area feature of the electronic document.

The above-mentioned operation (ii) of the method may comprise: determining that a first amount of a first primer with a low surface tension and a second amount of a second primer with a high surface tension is to be applied for pixels near or associated with a first feature of the electronic document; and determining that a different second amount of at least one of the first and second primers is to be applied for pixels near or associated with a second feature of the electronic document. The amount of primer may be defined in terms of drop size, dot size and/or percentage of a composite primer. For example, in some scenarios, the amount of each of the one or more primers may comprise: 51-100% of a first primer with a low surface tension and 0%-49% of a second primer with a high surface tension for a fine feature, small text, an edge of large text or a border of two adjacent colors in the at least one area of the electronic document; or 0%-49% of the first primer and 51-100% of the second primer for a middle of large text or a middle of an object in the at least one area of the electronic document. The primer(s) may comprise a polymer based liquid, a salt based liquid, a polymer and salt based liquid, or both a polymer based liquid and a salt based liquid. The primers may comprise at least two primers having different amounts of Surfactant or other substance for changing a surface tension of a liquid.

The characteristic of content in the electronic document may comprise: a type of image content, an ink color, or an ink type; and/or a type of image content selected from the group comprising a fine feature, small text, large text, and a solid object. The amount of each of the one or more primers may be determined based further on one or more of a media type, an actual temperature of media, an expected temperature of media, and scanner data from one or more previous print jobs.

The method may also comprise classifying said each pixel in the at least one area as being of a text edge pixel type, an object edge pixel type, or an adjacent color border type. The amount of each of the one or more primers may be determined based further on classifications of said each pixel. The identifying at least one area in the electronic document for which one or more primers are to be applied may comprise identifying a first area of the electronic document for which no ink is to be applied to the sheet of media and or a second area of the electronic document for which ink is to be applied to the sheet of media.

In some scenarios, the amount of each of the one or more primers may be zero for the first area of the electronic document and greater than zero for the second area of the electronic document. In other scenarios, the amount of each of the one or more primers may be one hundred percent for the first area of the electronic document and less than one hundred percent for the second area of the electronic document.

The present solution also concerns an implementing system comprising: a processor; and a non-transitory computer-readable medium. The processor may be configured to perform the above-described method and/or the non-transitory computer-readable medium may comprise one or more programming instructions that when executed by the processor, cause the processor to perform the above-described method. For example, the processor is otherwise caused to: identify at least one area in an electronic document for which one or more primers are to be applied prior to an application of ink on a sheet of media during a print job (wherein the primers are formulated to have different surface tensions); determine, for each pixel in the at least one area, an amount of each of the one or more primers that is to be applied based on a characteristic of content in the electronic document; generate the print job using the amount of each of the one or more primers determined for each said pixel in the at least one area; and instruct a printer to perform the print job. The printer may then perform the print job. The processor may be part of the printer or an accessory to the printer. Thus, the non-transitory computer-readable medium may also comprise one or more programming instructions to control the printer to perform and complete the print job.

The present solution further concerns another method for operating a printing system. The method comprises: identifying, by a processor, at least one two areas in an electronic document for which at least one primer is applied prior to an application of ink on a sheet of media during a print job (wherein the at least one primer is formulated to have a surface tension); determining, for each of the at least one two areas, a different amount of the at least one primer that is to be applied based on a characteristic of content in the electronic document; generating the print job using the amount of the at least one primer determined for each in the at least one area; instructing a printer to perform the print job; and controlling a printer to perform the print job. The amount of the primer may be defined by a drop size and/or other characteristic as described above.

The present solution further concerns a sheet of media, comprising at least one side on which one or more primers were applied during a print job based on characteristics of an electronic document. The primers are formulated to have different surface tensions. At least two areas of the at least one side of the sheet of media have different amounts of a single one of the primers applied thereto or different amounts of at least two of the primers applied thereto.

Use of the present solution is detectable. For example, a sheet of media printed in accordance with the present solution may have different amounts of ions in different areas thereof based on the primers respectively applied thereto.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

The described features, advantages and characteristics disclosed herein may be combined in any suitable manner. One skilled in the relevant art will recognize, in light of the description herein, that the disclosed systems and/or methods can be practiced without one or more of the specific features. In other instances, additional features and advantages may be recognized in certain scenarios that may not be present in all instances.

Although the systems and methods have been illustrated and described with respect to one or more implementations, equivalent alterations and modifications will occur to others skilled in the art upon the reading and understanding of this specification and the annexed drawings. In addition, while a particular feature may have been disclosed with respect to only one of several implementations, such feature may be combined with one or more other features of the other implementations as may be desired and advantageous for any given or particular application. Thus, the breadth and scope of the disclosure herein should not be limited by any of the above descriptions. Rather, the scope of the invention should be defined in accordance with the following claims and their equivalents.

What is claimed is:

1. A method for operating a printing system, comprising:
identifying, by a processor, at least one area in an electronic document for which one or more primers are to be applied prior to an application of ink on a sheet of media during a print job, wherein the primers are formulated to have different surface tensions;
determining, for each pixel in the at least one area, an amount of each of the one or more primers that is to be applied based on a characteristic of content in the electronic document;
generating the print job using the amount of each of the one or more primers determined for each said pixel in the at least one area; and
instructing a printer to perform the print job.

2. The method according to claim 1, wherein the print job comprises applying both a first primer with a low surface tension and a second primer with a high surface tension to the sheet of media at a location corresponding to the at least one area of the electronic document.

3. The method according to claim 1, wherein the print job comprises:
applying a lower surface tension primer to the sheet of media at a location that is associated with a text feature or a fine feature of the electronic document; and
applying a higher surface tension primer to the sheet of media at another location that is associated with a solid area feature of the electronic document.

4. The method according to claim 1, wherein said determining comprises:
determining that a first amount of a first primer with a low surface tension and a second amount of a second primer with a high surface tension is to be applied for pixels near or associated with a first feature of the electronic document; and
determining that a different second amount of at least one of the first and second primers is to be applied for pixels near or associated with a second feature of the electronic document.

5. The method according to claim 1, wherein the amount of each of the one or more primers comprises: 51-100% of a first primer with a low surface tension and 0%-49% of a second primer with a high surface tension for a fine feature, small text, an edge of large text or a border of two adjacent colors in the at least one area of the electronic document; or 0%-49% of the first primer and 51-100% of the second primer for a middle of large text or a middle of an object in the at least one area of the electronic document.

6. The method according to claim 1, wherein the at least two primers comprise a polymer based liquid, a salt based liquid, a polymer and salt based liquid, or both a polymer based liquid and a salt based liquid.

7. The method according to claim 1, wherein the one or more primers comprise at least two primers having different amounts of Surfactant.

8. The method according to claim 1, wherein the characteristic of content in the electronic document comprises a type of image content, an ink color, or an ink type.

9. The method according to claim 1, wherein the characteristic of content in the electronic document comprises a type of image content selected from the group comprising a fine feature, small text, large text, and a solid object.

10. The method according to claim 1, wherein the amount of each of the one or more primers is determined based further on one or more of a media type, an actual temperature of media, an expected temperature of media, and scanner data from one or more previous print jobs.

11. The method according to claim 1, further comprising:
classifying said each pixel in the at least one area as being of a text edge pixel type, an object edge pixel type, or an adjacent color border type;
wherein the amount of each of the one or more primers is determined based further on classifications of said each pixel.

12. The method according to claim 1, wherein the identifying at least one area in the electronic document for which one or more primers are to be applied comprises identifying a first area of the electronic document for which no ink is to be applied to the sheet of media and or a second area of the electronic document for which ink is to be applied to the sheet of media.

13. The method according to claim 12, wherein the amount of each of the one or more primers is zero for the first area of the electronic document and greater than zero for the second area of the electronic document.

14. The method according to claim 12, wherein the amount of each of the one or more primers is one hundred percent for the first area of the electronic document and less than one hundred percent for the second area of the electronic document.

15. A system, comprising:
a processor; and
a non-transitory computer-readable medium comprising one or more programming instructions that when executed by the processor, cause the processor to:
identify at least one area in an electronic document for which one or more primers are to be applied prior to an application of ink on a sheet of media during a print job, wherein the primers are formulated to have different surface tensions;
determine, for each pixel in the at least one area, an amount of each of the one or more primers that is to be applied based on a characteristic of content in the electronic document;
generate the print job using the amount of each of the one or more primers determined for each said pixel in the at least one area; and
instruct a printer to perform the print job.

16. The system according to claim 15, wherein the print job comprises applying both a first primer with a low surface tension and a second primer with a high surface tension to the sheet of media at a location corresponding to the at least one area of the electronic document.

17. The system according to claim 15, wherein the print job comprises:
applying a lower surface tension primer to the sheet of media at a location that is associated with a text feature or a fine feature of the electronic document; and
applying a higher surface tension primer to the sheet of media at another location that is associated with a solid area feature of the electronic document.

18. The system according to claim 15, wherein processor is further causes to:
determine that a first amount of a first primer with a low surface tension and a second amount of a second primer with a high surface tension is to be applied for pixels near or associated with a first feature of the electronic document; and
determine that a different second amount of at least one of the first and second primers is to be applied for pixels near or associated with a second feature of the electronic document.

19. The system according to claim 15, wherein the amount of each of the one or more primers comprises: 51-100% of a first primer with a low surface tension and 0%-49% of a second primer with a high surface tension for a fine feature, small text, an edge of large text or a border of two adjacent colors in the at least one area of the electronic document; or 0%-49% of the first primer and 51-100% of the second primer for a middle of large text or a middle of an object in the at least one area of the electronic document.

20. The system according to claim 15, wherein the at least two primers comprise a polymer based liquid, a salt based liquid, a polymer and salt based liquid, or both a polymer based liquid and a salt based liquid.

21. The system according to claim 15, wherein the one or more primers comprise at least two primers having different amounts of Surfactant.

22. The system according to claim 15, wherein the characteristic of content in the electronic document comprises a type of image content, an ink color, or an ink type.

23. The system according to claim 15, wherein the characteristic of content in the electronic document comprises a type of image content selected from the group comprising a fine feature, small text, large text, and a solid object.

24. The system according to claim 15, wherein the amount of each of the one or more primers is determined based further on one or more of a media type, an actual temperature of media, an expected temperature of media, and scanner data from one or more previous print jobs.

25. The system according to claim 15, wherein the processor is further caused to:
classify said each pixel in the at least one area as being of a text edge pixel type, an object edge pixel type, or an adjacent color border type;
wherein the amount of each of the one or more primers is determined based further on classifications of said each pixel.

26. The system according to claim 15, wherein the processor is further caused to identify a first area of the electronic document for which no ink is to be applied to the sheet of media and or a second area of the electronic document for which ink is to be applied to the sheet of media.

27. The system according to claim 26, wherein the amount of each of the one or more primers is zero for the first area of the electronic document and greater than zero for the second area of the electronic document.

28. The system according to claim 26, wherein the amount of each of the one or more primers is one hundred percent for the first area of the electronic document and less than one hundred percent for the second area of the electronic document.

29. A method for operating a printing system, comprising:
identifying, by a processor, at least one two areas in an electronic document for which at least one primer is applied prior to an application of ink on a sheet of media during a print job, wherein the at least one primer is formulated to have a surface tension;
determining, for each of the at least one two areas, a different amount of the at least one primer that is to be applied based on a characteristic of content in the electronic document;
generating the print job using the amount of the at least one primer determined for each in the at least one area; and
instructing a printer to perform the print job.

30. The method according to claim 29, wherein the amount of the at least one primer is defined by a drop size.

31. A sheet of media, comprising:
at least one side on which one or more primers were applied during a print job based on characteristics of an electronic document;
wherein the primers are formulated to have different surface tensions;
wherein at least two areas of the at least one side of the sheet of media have different amounts of a single one of the primers applied thereto or different amounts of at least two of the primers applied thereto.
